(19) United States
(12) Patent Application Publication
(10) Pub. No.: US 2009/0077895 A1
(43) Pub. Date: Mar. 26, 2009

(54) Automatic door bottom with release mechanism

(76) Inventor: Adi Tshai, Elmhurst, NY (US)

Correspondence Address: Allan Chan;Suite 700, 225 Broadway, New York, NY, 10007, US

(21) Appl. No.: 12/283,442

(22) Filed: Sep. 12, 2008

Related U.S. Application Data
(60) Provisional application No. 60/995,659, filed on Sep. 26, 2007.

(51) Int. Cl. E05F 11/54; E05F 15/12; E06B 7/28

(52) U.S. Cl. 49/316; 49/358; 49/357

(57) ABSTRACT

This invention relates to automatic door bottom with a release mechanism for a hinged door which is pivotable to be positioned over a sill when closed, a sealing member having a length corresponding to the length of the channel, the sealing member being housed in the channel of said and being movable vertically downwardly into a sealing position in which the sealing member will contact the sill when the door is closed, alternatively said sealing member may be manually moved upwardly even when the door is in the closed position.

### SUMMARY OF THE INVENTION

This invention relates to an automatic door bottom with release mechanism. An automatic door bottom is a device attached to bottom part of a door by mounting means, for example by screws. The term Automatic Door Bottom and Door Bottom will be used interchangeably in the description of this invention.

The current invention allows a person to selectively seal or unseal a door bottom when said door is in the closed state. Said release mechanism to the automatic door bottom may be actuated remotely or in close proximity. The mechanism utilized to release the automatic door bottom may be through mechanical force or electrical forces.

A door is described as an enclosure of an opening. Perimeter around the door on the left and right side are referred as jambs. Part of floor bellow the bottom part of the door is referred as door sill. A swing door is describe as a door which is pivot mounted to one side of the jamb by mounting means generally referred as hinges. The side of the door near to the hinges is referred as hinged side, the side farthest from the hinges is referred as unhinged side. The opening and closing of said door is by operating a swinging action to the door around the hinges. A gap generally exist between bottom part of the door and its sill as the door is in closed position.

The Door Bottom has a housing in the form of an inverted channel with an open bottom toward the door sill, with length corresponding to the door width. The Door Bottom has at least one sealing member, installed at the open bottom of said channel.

A displacement mechanism is coupled to the sealing member at one or multiple points to actuate the sealing member. The displacement mechanism has at least one operating member and at least one resilient member. At least one operating member cooperate with at least one stationary abutment around perimeter of the door to operate the displacement mechanism, and displace the sealing member. A release mechanism is activated by other means of actuation to disengage the displacement mechanism from actuating the sealing member.

The sealing member in this invention consist of a compressible and elastic sealing element and a generally H-shape rigid member to support the sealing element. The sealing member can be reciprocally lowered in to a first sealing position and retracted to the channel into second unsealing position. The first and second position corresponding respectively to a close and an open door. The purpose for such sealing position are in general to block drafts, light, noise, and foreign object from passing through the gap.

Furthermore the reciprocal action creates a first correlation of a close door correlate to a sealed gap, and second correlation of an open door correlate to an unsealed gap. An Automatic Door Bottom with release mechanism in this invention creates a third correlation where a closed door correlate to its gap unsealed.

### BRIEF DESCRIPTION OF DRAWING

FIG. 1 is an elevation view of an Automatic Door Bottom with release mechanism according to the first embodiment of the invention mounted on a closed swing door.

FIG. 2 is a perspective view of FIG. 1 showing the door slightly open, showing bottom part at hinged side.

FIG. 3 is side cross section view of line (III-III) of FIG. 1.

FIG. 4 is elevation view of the other side of the door from FIG. 2, showing one side of foot operated lever as an actuator for release mechanism

FIG. 5 is a plan, cross section view of line (V-V) in FIG. 4

FIG. 6 is a exploded perspective view of FIG. 1 showing components of Automatic Door Bottom with release mechanism according to first embodiment of the invention.

FIG. 7 is a general cross section view of FIG. 3 showing channel of Automatic Door Bottom

FIG. 8 is a view similar to FIG. 3, illustrating a modified version of embodiments of the invention with Automatic Door Bottom flush mounted to the door leaf.

FIG. 9 is a view similar to FIG. 3, illustrating a modified version of embodiments of the invention with with Automatic Door Bottom mortise mounted to the door.

FIGS. 10a, 10b, and 10c are partial front view of displacement mechanism of the first embodiment of the invention.

FIGS. 11, 12, 13, and 14 are front view of the first embodiment of the invention showing four successive operating stages.

FIG. 15 is an elevation view of a modified version of FIG. 1 showing solenoid as an actuator for release mechanism.

FIG. 16 is a perspective view of FIG. 15.

FIGS. 17a, 17b, and 17c are partial front view of displacement mechanism according to the second embodiment of the invention.

FIG. 18 is front view bottom part of unhinged side of a swing door, showing a door knob as an actuator for release mechanism.

FIG. 19 is a detailed perspective view of door knob adapter in FIG. 18.

FIGS. 20, 21, 22, and 23 are front diagram view of second embodiment of the invention, showing four successive operating stages.

FIGS. 24a and 24b are partial front view of displacement mechanism according to the third embodiment of the invention.

FIGS. 25, 26, and 27 are front diagram view of third embodiment of the invention, showing three successive operating stages.

### DETAILED DESCRIPTION OF PREFERRED EMBODIMENTS

The contents of U.S. Pat. No. 4,947,584, U.S. Pat. No. 6,125,584, and U.S. Pat Application No. 20040010973 are incorporated hereby in their entirety by reference.

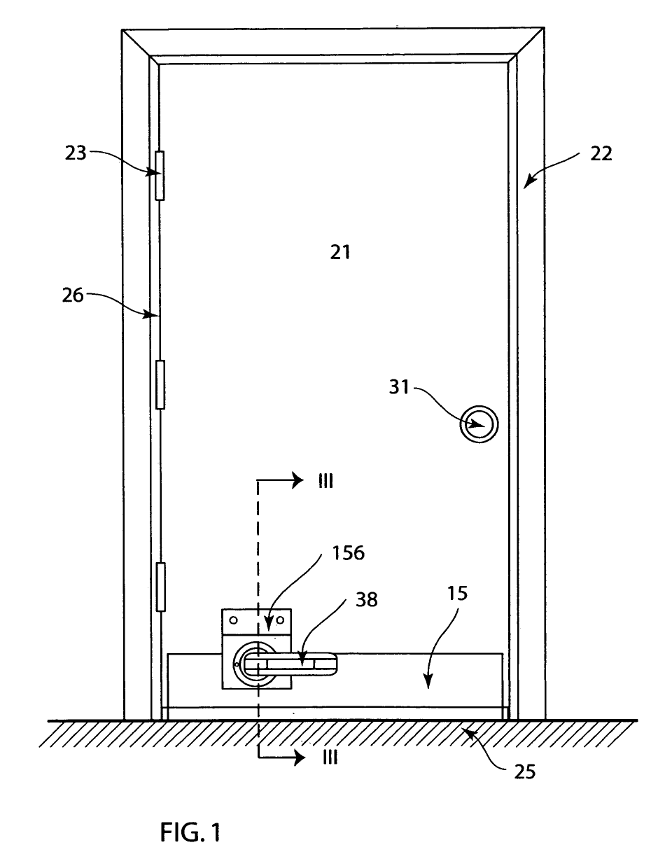

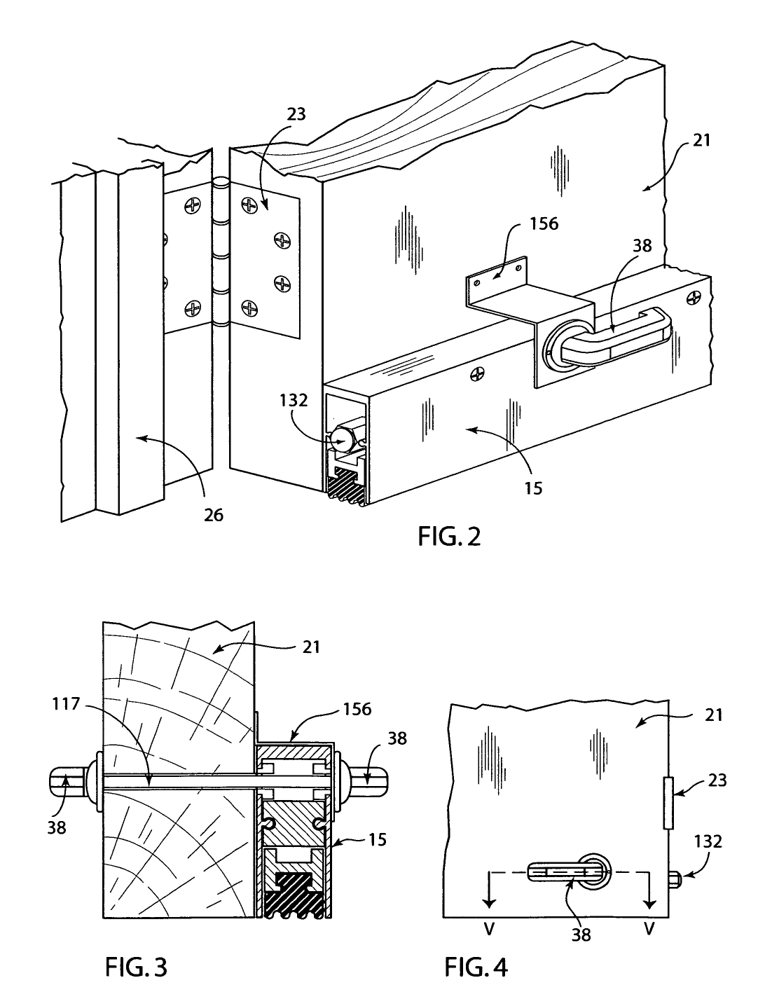

FIG. 1 shows the preferred first embodiment of the invention which is a front view of a swing door 21 in closed position, mounted to doorjamb 26 by means of hinges 23. The door 21 is provided with door knob 31 which operate a spring loaded latch (not shown in the figure). An alternative for door knob for example a hand lever can also be used, but not shown commonly known to persons skilled in the art. An Automatic Door Bottom with release mechanism 22 can be surface mounted on the door or inserted in a hollow in the bottom portion of said door, with two foot operated levers 38, to operate the release mechanism. Preferably, at least one lever 38 is mounted to the door by mounting plate 158. Alternatively any form of switching mechanism commonly known to persons skilled in the art may be used, including but not limited to a push button mechanism, upwardly moving latch, laterally moving latch, or a pulling mechanism. FIG. 4 shows the preferred embodiment with the lever on the other side of the door from FIG. 1. The operation of levers 38 are clockwise turn in FIG. 1 and counterclockwise turn in FIG. 4. FIG. 3 is a side cross sectional view of line (III-III) of FIG. 1, showing the connection between Door Bottom 21 and lever 38 by a spindle 117. FIG. 2 is perspective view of FIG. 1, showing a partially opened door with a more detailed part of Door Bottom at hinges side.

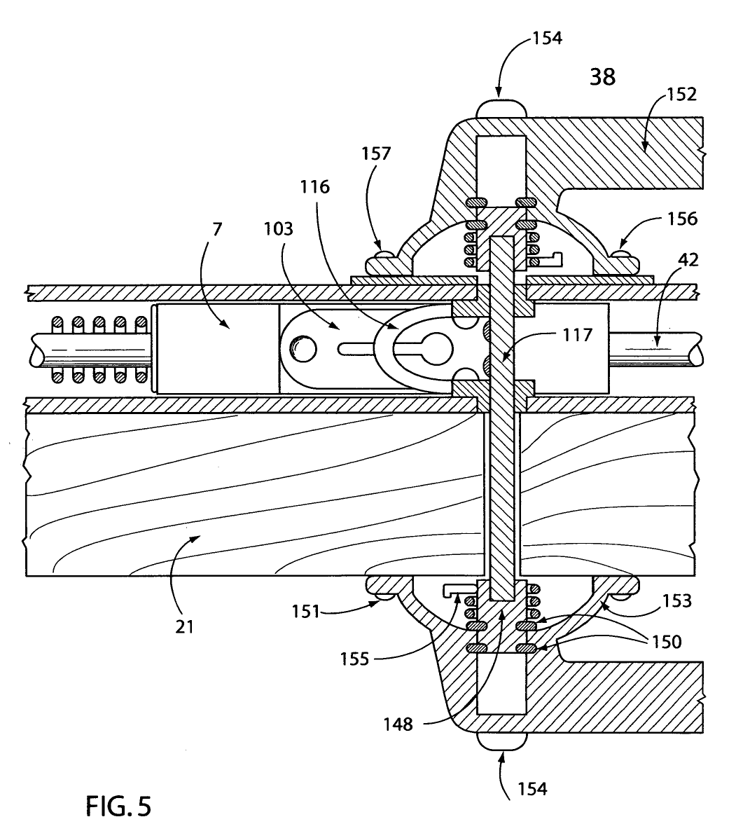

FIG. 5 is a plan cross section view at line (V-V) of FIG. 4, showing detail relationship between Door Bottom and levers 38. In the preferred embodiment levers have component of a mirror image pair of lever handles 152, mounted to shafts 148 by means of screws 154. Each shaft 148 is held in place with a pair of washers 150 to the base plate 153, which in turn are mounted to door 21 directly or indirectly. FIG. 4 show direct mounting of lever 38 to the door 21 by screws 151, FIG. 1 show indirect mounting through mounting plate 156 by screws 157. The plate is mounted directly to door 21 by screw 151. Preferably torsional springs 155 are mounted at one end to the shaft 148 and at other end to base plate 153. This to enables levers 38 to spring back to its normal position. In an alternative embodiment, said lever moves into various positions manually without the aid of any mechanical forces. The pair of levers 38 are connected to each other by a square shape spindle 117, and are connected to the release mechanism through rocker 116. The rocker 116 is preferably made from injection molding resilient plastic. All parts of said invention may be constructed from different types of materials commonly known to persons skilled in the art for their desired purpose.

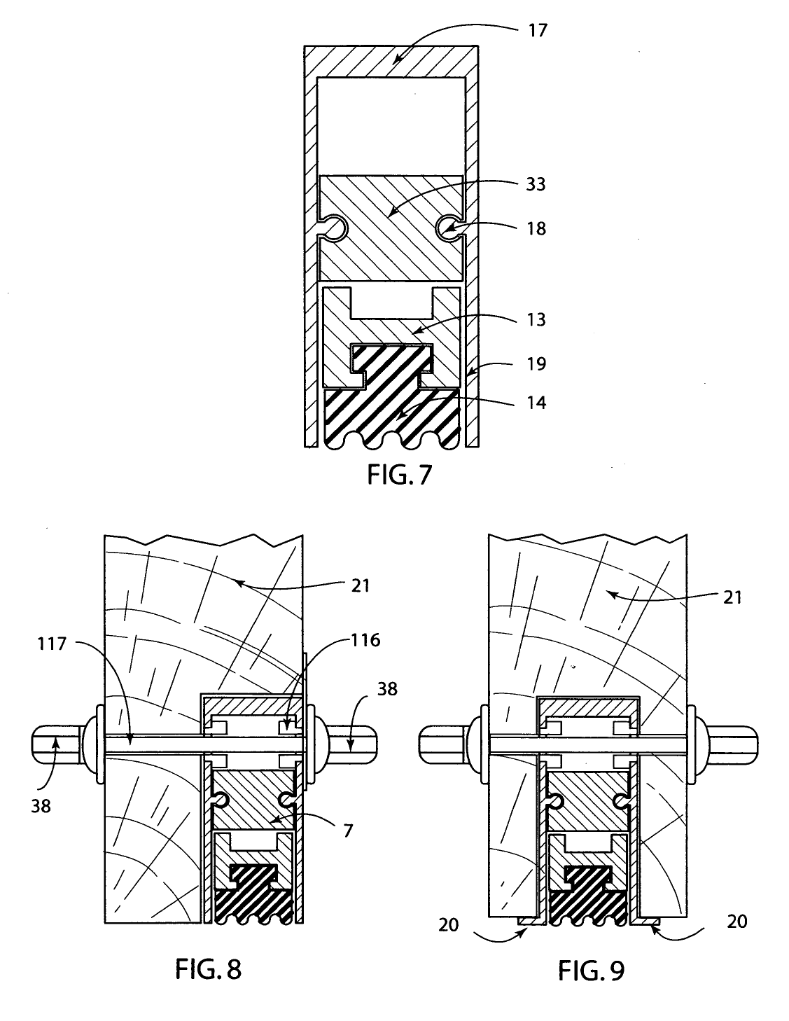

FIG. 7 shows an alternative embodiment, a general cross section view of channel 15, an extruded inverted U-shape with length corresponding to width of door 21. Channel 15 has top wall 17, a pair of legs 19, and optionally a pair of feet 20 as shown in FIG. 9. A pair of rails 18 are provided for general form of block referred by numeral 33 to move freely along the channel 15. Various blocks used in this invention have cut out shape of block 33 to accommodate rails 18, but can have different internal shape and numerical references shape depending on their functions. Alternatively, additional mechanism maybe inserted into a cavity form by channel 15 if desired. Mechanism such as a temperature sensor may be inserted into said cavity to notify persons of dangerous fire conditions.

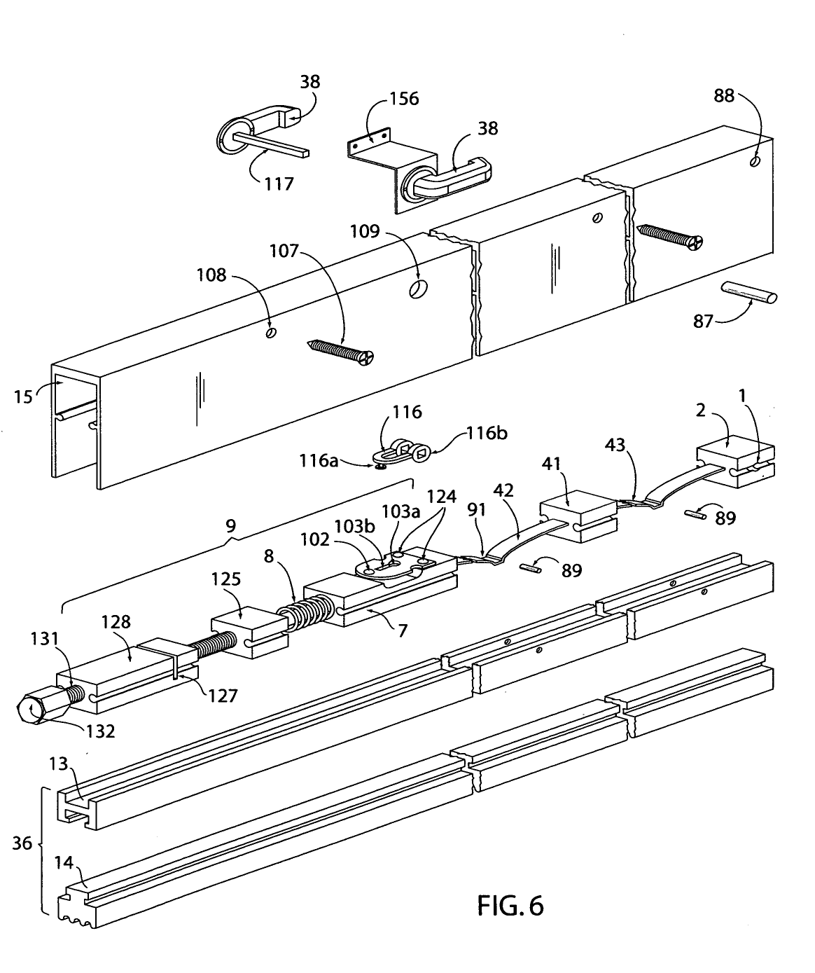

FIG. 6 is an exploded view of first embodiment of the invention. The channel 15 is surface mounted to the door by means of mounting screws 107 through in line mounting holes 108, extending along the length of the Door Bottom. A pair of levers 38 are connected to channel 15 by spindle 117 through in line holes 109 on both side of legs 19 of the channel. Inside the channel 15, the spindle 117 pass thorough holes 116b of rocker 116. The Rocker 116 is snapped in to in line holes 109 from inside the channel 15. A hook 116a is slided into slot 103b through holes 103a, securely coupling rocker 116 to leaf spring 103.

The displacement mechanism consists of release mechanism referred with numeral 9 and resilient members such as a leaf spring 42 and 43. Members 42 and 43 are connected to each other by connecting block 41, and terminated at one end by end block 2. The end block 2 is fixedly mounted to the channel 15, by a pin 87 that pass though in line holes 88 of channel 15 channel and hole 1 of end block 2.

The release mechanism 9 has members of a hollow block 128, an adjustment block 125, and a housing 7. The blocks mentioned above generally take shape of block 33, and are able to move freely along the channel 15 lengthwise.

A H-shape rigid housing 13 hold compressible sealing element 14 in place. The sealing element generally slide in the housing 13 and fixed in place for example by adhesive or any form of mechanical mounting mechanisms commonly known to persons skilled in the art to form sealing member 36. The displacement mechanism are connected to the sealing member 36, by mounting middle sections of spring 42, and 43 to pins 89 which are slide through in line holes on the housing 13. The mounting is in such a way, that a limited movement of sealing member 36 lengthwise are permitted, but vertical movement across the width of channel downward are restricted by both leaf spring 42 and or 43.

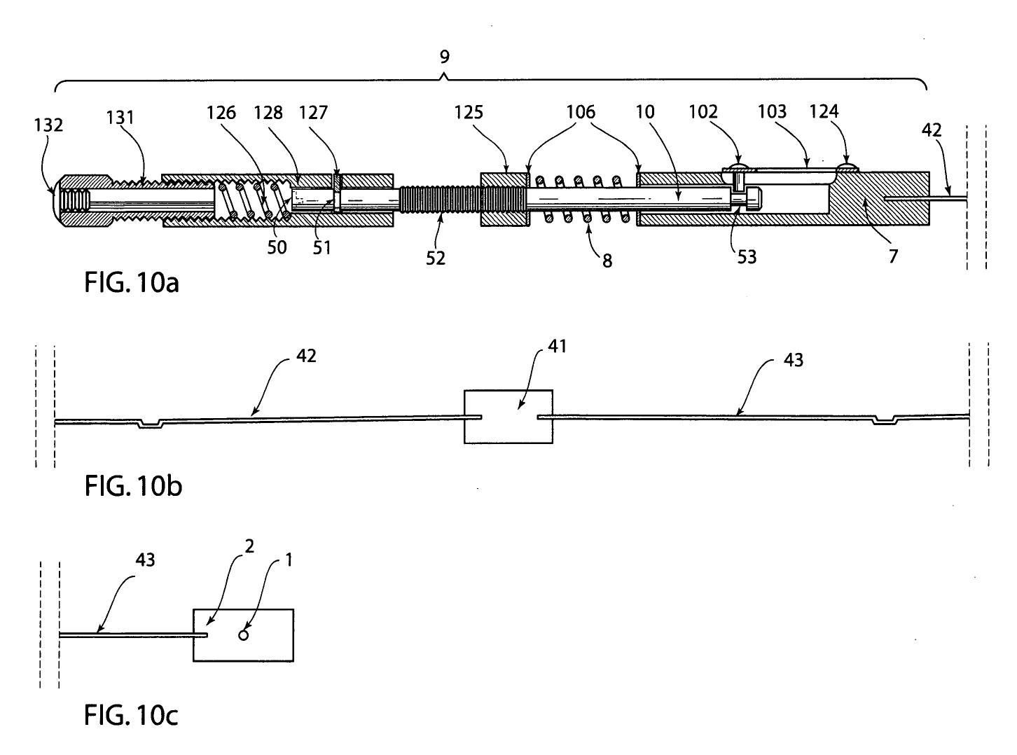

FIGS. 10a, 10b, and 10c are partial front view of displacement mechanism of the automatic door bottom with release mechanism according to the first embodiment of the invention. To form a complete figure, join the right side of FIG. 10A to the left side of FIG. 10b, and likewise join the right side of FIG. 10b to the left side of FIG. 10C. Tensional mechanisms such as but not limited to leaf springs may be used. Alternatively other forms of tensional mechanism maybe utilized as commonly known to persons skilled in the art. Leaf springs 42 and 43 are provided as such that spring constant of spring 42 is smaller than spring constant of leaf spring 43. In FIG. 10A, the housing 7 could be joined directly with spring 42 or indirectly by another connecting block 41.The housing 7 take general shape of block 33 as in FIG. 7, has a bore hole at one end to accommodate shaft 10, and an opening from top part toward its hollow middle. Leaf spring 103 is mounted to housing 7 by rivet 124 at one end, and has latch pin 102 in other end. The latch pin 102 extend from end of leaf spring 103 into the hollow middle of housing 7, latching shaft 10 at its annular grove 53.

Hollow block 128 has an interior thread which in cooperation with hollow adjustment cylinder 131 to adjust length of operation for displacement mechanism. An adjustment is executed by turning the head of cylinder 131, preferably in hexagonal shape. A spring 126 is provided to prevent accidental turning of cylinder 131.

Cushion 132 is removable to enable a screw driver to access screw head 50. The shaft 10 has one annular grove 51, which is retained by retaining ring 127 at hollow block 128. A threaded area 52 threaded into hollow block 125 which has interior thread. The helical spring 8, assisted with a pair of washer 106, is situated between block 125 and housing 7. An operation of turning the screw head 50, in cooperation with the annular groove being latched by latch pin 102, cause hollow block 125 to move along threaded region 52, effectively adjust tension of helical spring 8.

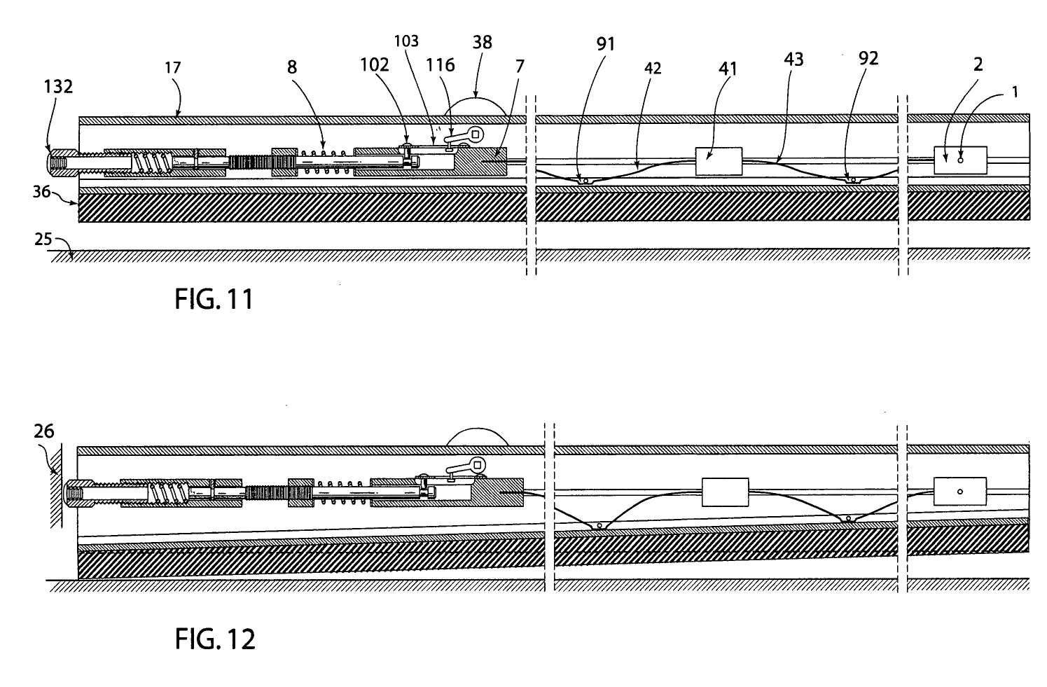

FIGS. 11, 12, 13, and 14 show respectively operating stages one, two, three and four of the first embodiment of the invention. Stage one represent a door in open position, stage two represent door in almost closed position, stage three represent a door in closed position, and stage four represent door in closed position with release mechanism activated.

At stage one, sealing member 36 is retract inside channel 15, cushion 132 is disengage from jamb 26, and shaft 10 are latched to housing 7 by means of latch pin 102. Rocker 116, are engage in slot of leaf spring 103. Condition of stage one are shown in FIG. 11.

As the door is closing, at one point cushion 132 engage with door jamb 26 at hinged side. At first, due to its lower spring constant leaf spring 42 will flex down, and bring sealing member 36 at coupling point 91 downwardly until sealing member 36 contact with door sill 25. Housing 7 move along the housing to the right in the figure, causing rocker 116 to slide along the slot of spring 103 closer to latch pin 102. FIG. 12 show condition of door bottom of stage two.

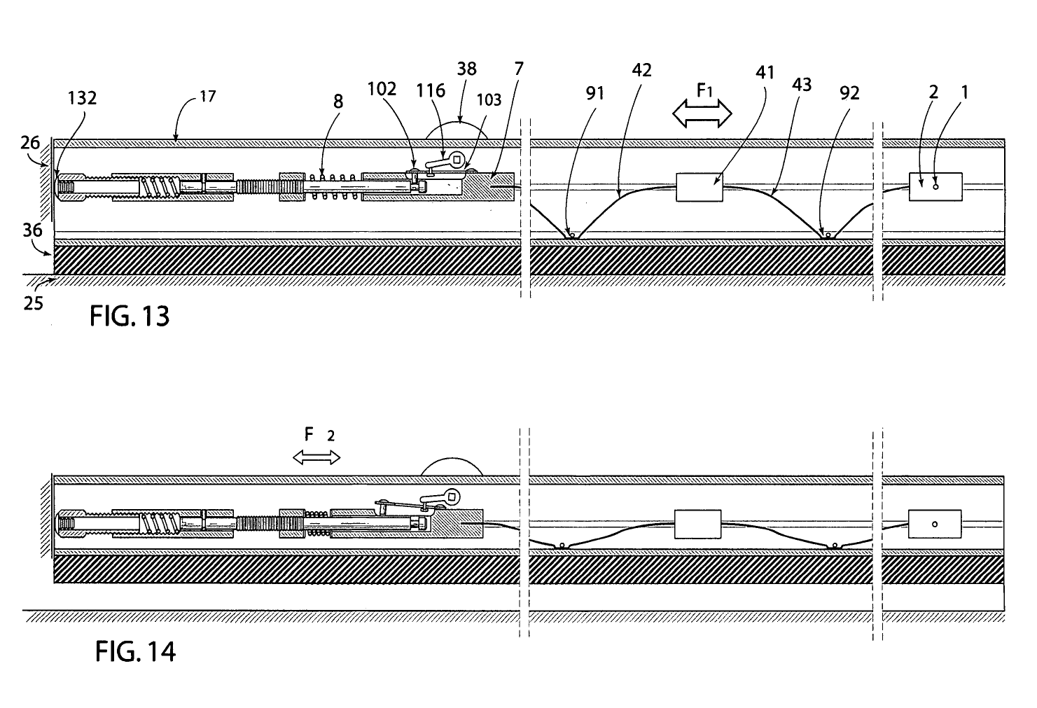

A further closing of the door 21 cause rocker 116 to move more closely to latch pin 102. A further closing also cause spring 43 to flex and bring the remaining part of sealing member downwardly by coupling point 92, until the door is completely closed and sealing element is fully in contact with door sill 25. Springs 42 and 43 as combined have spring tension F1. FIG. 13 show condition of door bottom at stage three.

An action of operating either one of the levers 38 cause rocker 116 in cooperation with leaf spring 103 release latch pin 102 from latching onto shaft 10. Tension F1 cause spring 42 and 43 to unflex, causing housing 7 to move to the left side in FIG. 14, and in turn depress helical spring 8. Since spring constant helical spring 8 is designed to be significantly smaller than spring constant of leaf spring 43, the net result will cause sealing member 36 to significantly retracted into the channel 15. Spring 8 will eventually compressed and has tension F2 which is significantly smaller that F1.

When the door 21 is eventually opened, tension F2 of helical spring 8 would pull shaft 10 out of housing 7 until it is latch by latch pin 102. This effectively reset the release mechanism 9 and set condition of Door Bottom to the stage one of operation as shown in FIG. 11.

According to this embodiment of the invention, stages one, two, and three are normal operation stages for the Automatic Door Bottom with release mechanism. Operation stage four is optional and active only if release mechanism 9 is actuated by an actuator.

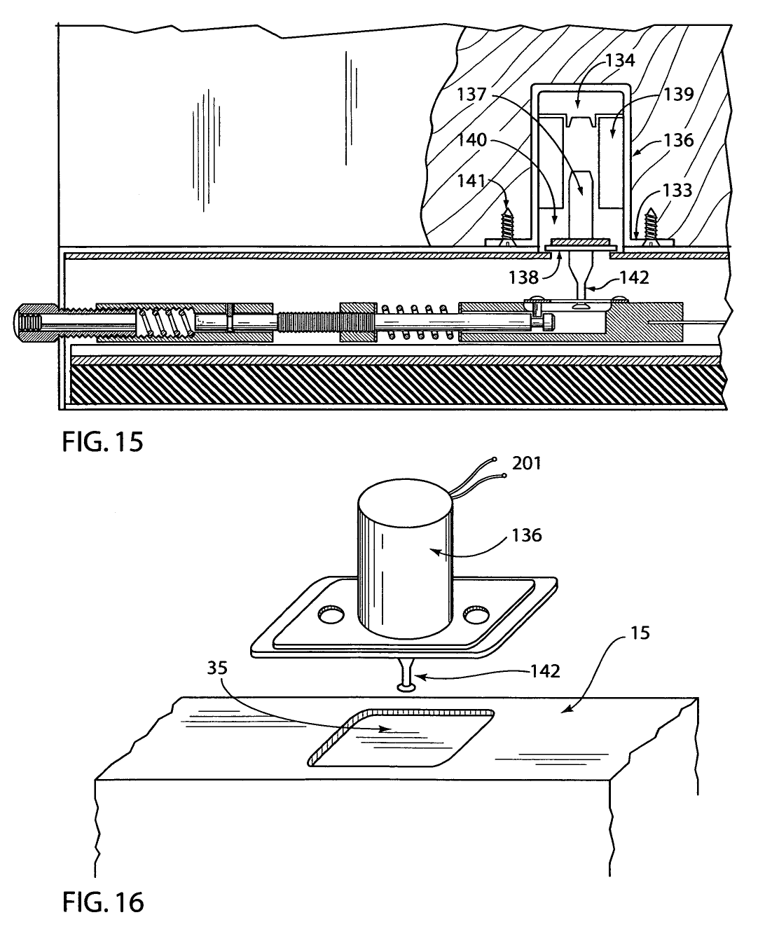

The release mechanism 9 can furthermore be actuated by another means. FIGS. 15 and 16 show one alternative of actuating the release mechanism by means of a solenoid. This actuating mechanism is preferable for Door Bottom 22 mortised mounted to the door 21 similar to mounting in FIG. 9.

The solenoid consists of: a frame 136 a mounting plate 133, a plunger 137 with washer 138 and E-ring 140, End stop 134, and coil 139. The mounting plate 133 is mounted into the mortised part of door upward with mounting screws 141. The plunger 137 projects into the channel 15 at an opening 35 on the top wall 17. A hook 142 at the end of plunger 137 is slided into slot of leaf spring 103, by method similar to insertion of rocker 117 to spring 103 in FIG. 6.

An action of energizing coil 139 will cause pull action by plunger 137, and actuate release mechanism 9. This action can be done by means of a switch that temporarily connect the coil 137 to any suitable source of electricity energy for example a battery. Furthermore the switch can be related to an action turning the door knob 31 (as in FIG. 1), for example by installing a switch that can be activated by rotation of door knob. The suitable source of electricity and means to activate the switch are well known to persons skilled in the art.

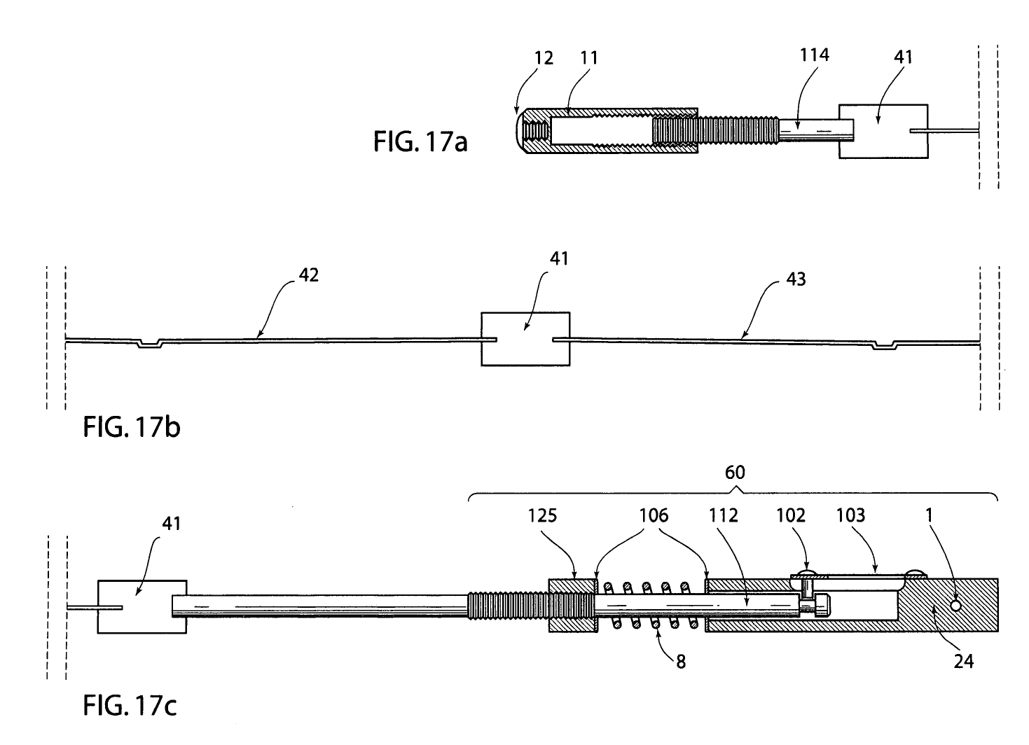

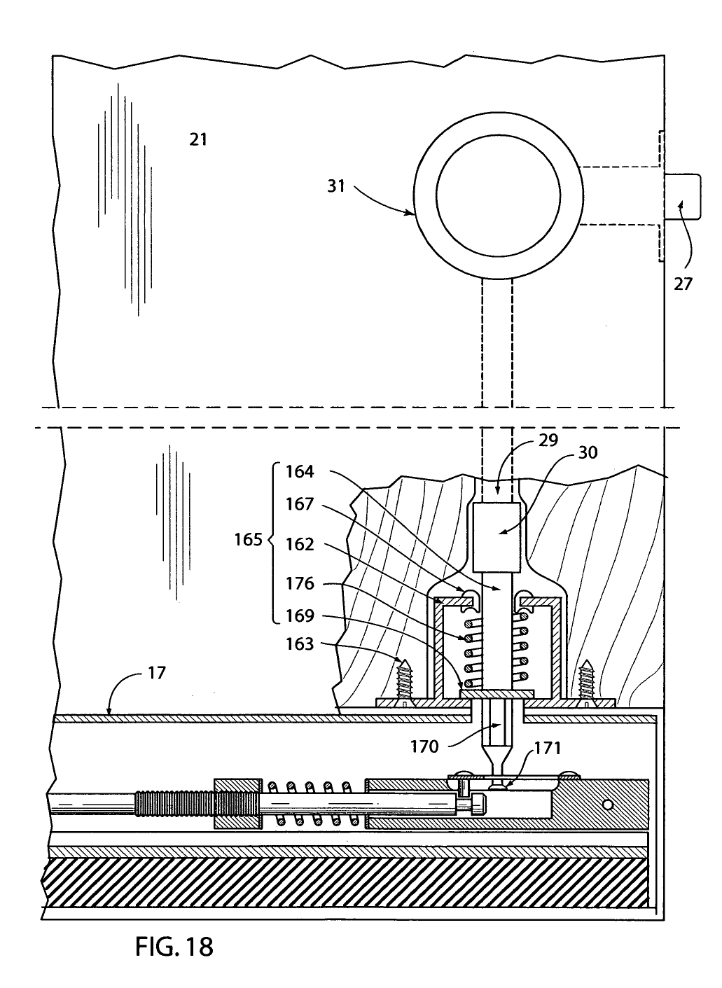

FIGS. 17a, 17b, and 17c show partial front view of displacement mechanism according to the second embodiment of the invention. To form a complete figure, join the right side of FIG. 17A to the left side of FIG. 17b, and likewise join the right side of FIG. 17b to the left side of FIG. 17C.

The release mechanism is referred as numeral 60 and resemble release mechanism 9 with several exceptions. Housing 24 resemble housing 7, with exception that housing 24 has a termination hole 1. Shaft 112 similar to shaft 10, with exception shaft 112 does not have screw head 50 and grove 51. Housing 24 is fixably mounted at hole 1 to channel 15 by means of mounting means similar to mounting means for end block 2 in FIG. 4.

Adjustment nut 11 with cushion 12, adjust effective length of operation of displacement mechanism.

FIG. 18 show an alternative of actuating mechanism for this embodiment by operating door knob 31. The actuating mechanism consist of an adapter 28 (not shown in this figure) and an actuator 165. The actuator has an housing 162 and mounted to upper part bottom part of door 21 by mounting screw 163. The actuator consist of a shaft 164 with threaded top end and hexagonal shape bottom 170. The end bottom part are provided with a hook form 171. The hook 171 is slotted into slot of leaf spring 103. The shaft is suspended at the lower part with washer 169, and a helical spring 176, and upper part by a sleeve 167. At the top most part of shaft 164, are connected to shaft 29 by shaft connector 30. The actuator 165 is operable by knob 31 through adapter 28. Adapter 28 is not shown in this figure.

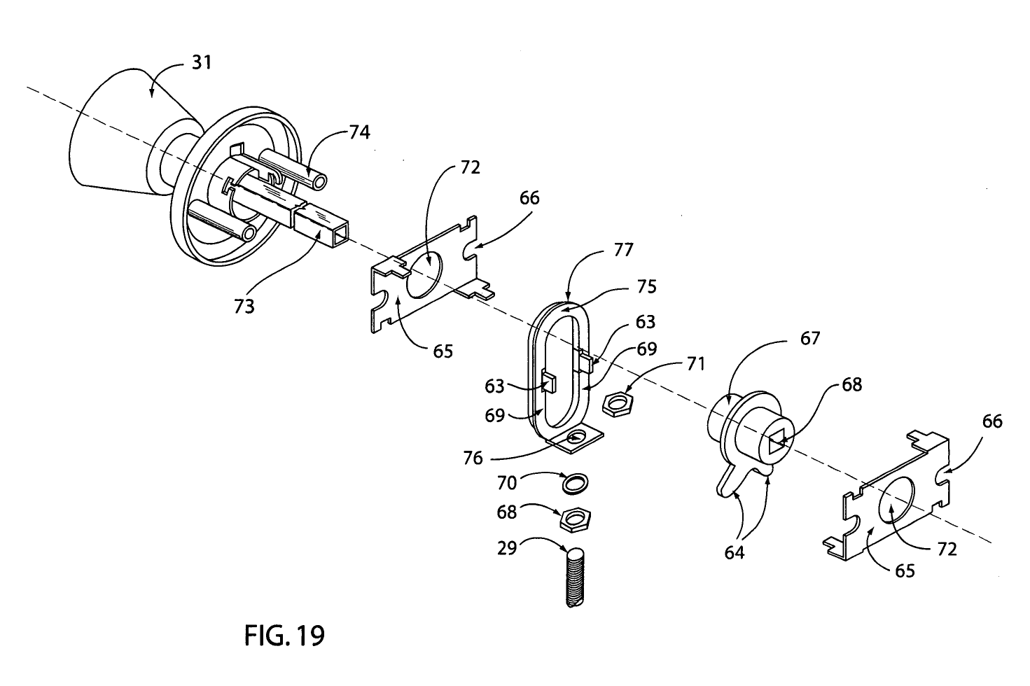

Adapter 28 can be constructed similar to U.S. Pat. No. 6,030,008. An adaptation of the patent to fit this invention is shown in FIG. 19.

A pair of fastening plates 65 are provided with confining holes 66 and holes 72. Confining holes 66 are confined into alignment rods 74. Into holes 72, A rotary wheel 67 is provided with a through hole 68 and two moving teeth 64 engage able with either part of projections 63 of two action arms 69. The moving teeth 64 of rotary wheel 67 is actuated by door knob 31, which is engaged with the through hole 68 by mean of spindle 73, thereby causing the moving teeth to pull up either part of projection 63, depending on action of operation of door knob. As it is seen from the side of door knob 31 in the figure, an action of turning the knob clockwise cause moving teeth 64 to move counterclockwise and engage with right hand side of action arm 63. And vise versa, an action of turning the knob 31 counterclockwise, cause moving teeth 64 turn clockwise and engage with left hand side of action arms 69.

A body 77 provided at lower end with attachment hole 76 and a collar 75 at upper end. The attachment hole 76 is provided for connection to shaft 29. The shaft 29 is fastened to hole 76 by nuts 71 and slip ring 70. The collar 75 rest on one side of rotary wheel 67.

A spring loaded door latch 27 as shown in FIG. 18 are operable by door knob 31 in a way that it is mutually exclusive from adapter 28.

The operation of this actuating mechanism are operated from turning door knob 31, pull-up action by adapter 28, shaft 29, connector 30, shaft 164, and hook 171. A cooperation of sleeve 167, helical spring 176, and washer 169 will push the hook 171 down, to reset the pull-up action by operation of actuation.

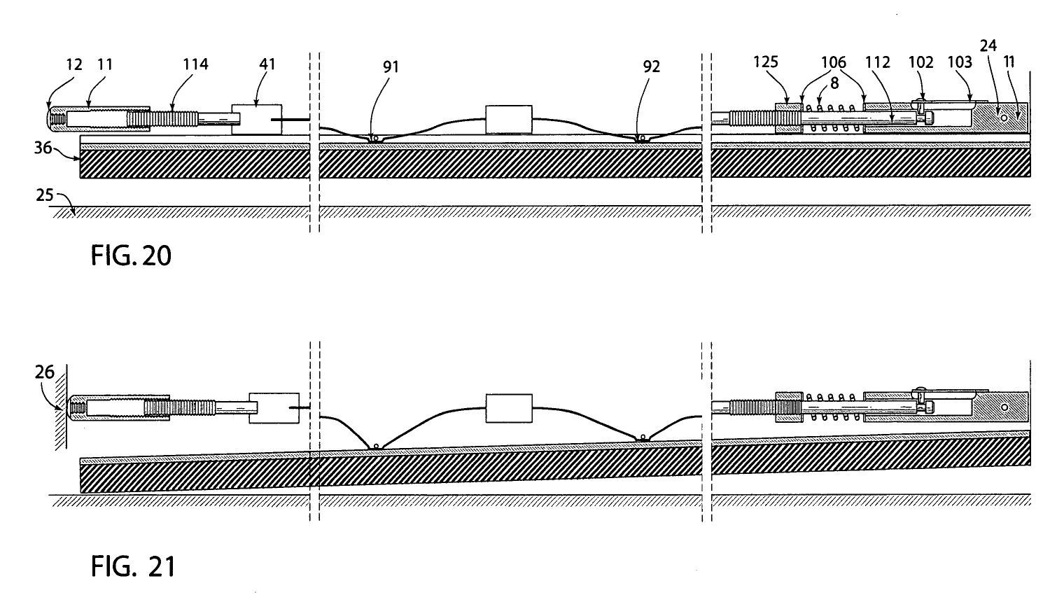

FIGS. 20, 21, 22, and 23 show respectively operating stages one, two, three and four according to the second embodiment of the invention. Stage one represent a door in open position, stage two represent door in almost closed position, stage three represent a door in closed position, and stage four represent door in closed position with release mechanism activated.

As door 21 is closing, cushion 12 with engage with jamb 26 causing spring 42 to flex and bring down associated sealing member 36 at hinged side to move downwardly until contact with sill 25, as is shown in FIG. 21.

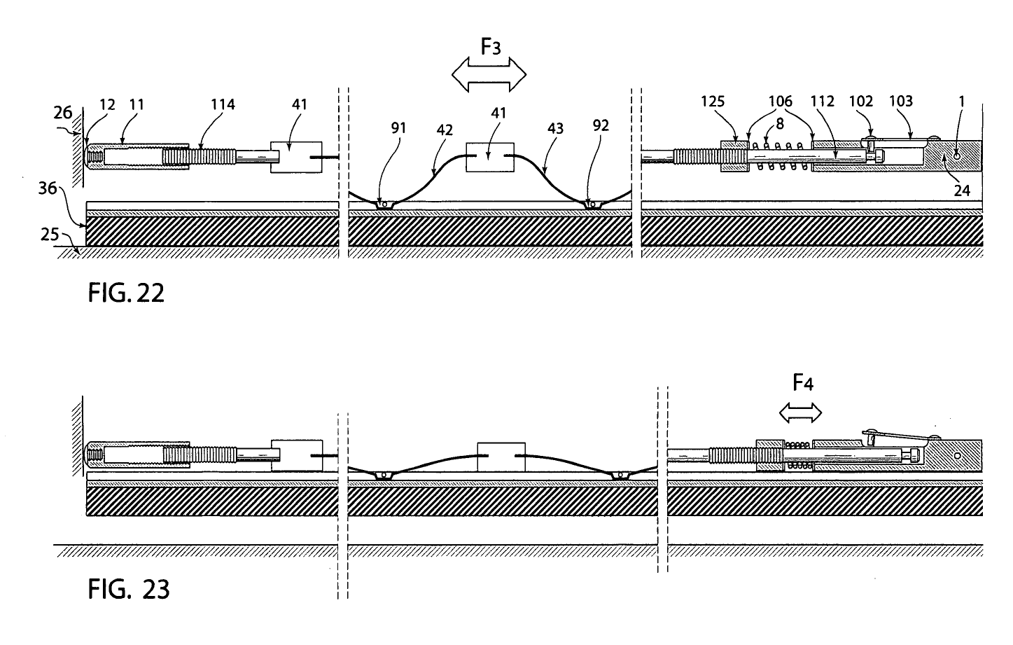

A further closing of door 21 will flex spring 43 and bring associated sealing member 36 at unhinged side to come to contact sill 25 until the sealing member is completely in contact with sill 25 and door 21 is completely closed, as shown in FIG. 22. Spring 42 and 43 will retain force F3.

With actuation mechanism similar to description in FIGS. 18 and 19. An action of turning door knob 31, would activate release mechanism 60. As result latch pin 102 release the shaft 112. In absent of latching of shaft 112, helical spring 8 will be depressed by force F3, and eventually retain force F4. The sealing members as significantly retracted into the channel 15, as shown in FIG. 23.

According to this actuation mechanism stage one, two, three and four are normal routine stage of operation of the Door Bottom. The action of turning door knob 31 will actuate the release mechanism and a precursor to open the door 21, or it can be an action just to actuate the release mechanism 60 without actually opening the door.

Furthermore, alternatives to actuate release mechanism can be by means of mechanical lever as shown in FIG. 5, or by means of solenoids as shown in FIGS. 15 and 16.

The Door Bottom 22 according to the second embodiment can be surface mounted similar to FIG. 3, or it can be flush mounted similar to FIG. 8.

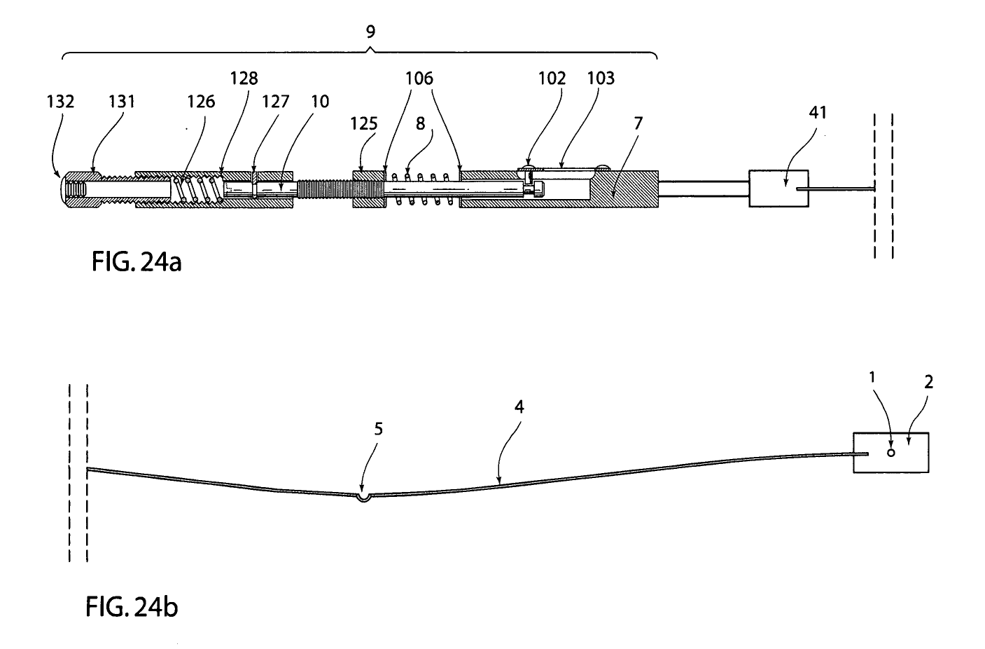

FIGS. 24a, 24b show partial view of displacement mechanism with release mechanism according to the third embodiment of the invention. To form a complete figure, join the right side of FIG. 24A to the left side of FIG. 24b. FIG. 24A is the same with FIG. 10A, with on exception that it is connected to a connecting block 41. Description of FIG. 24a follow the same description for FIG. 10a.

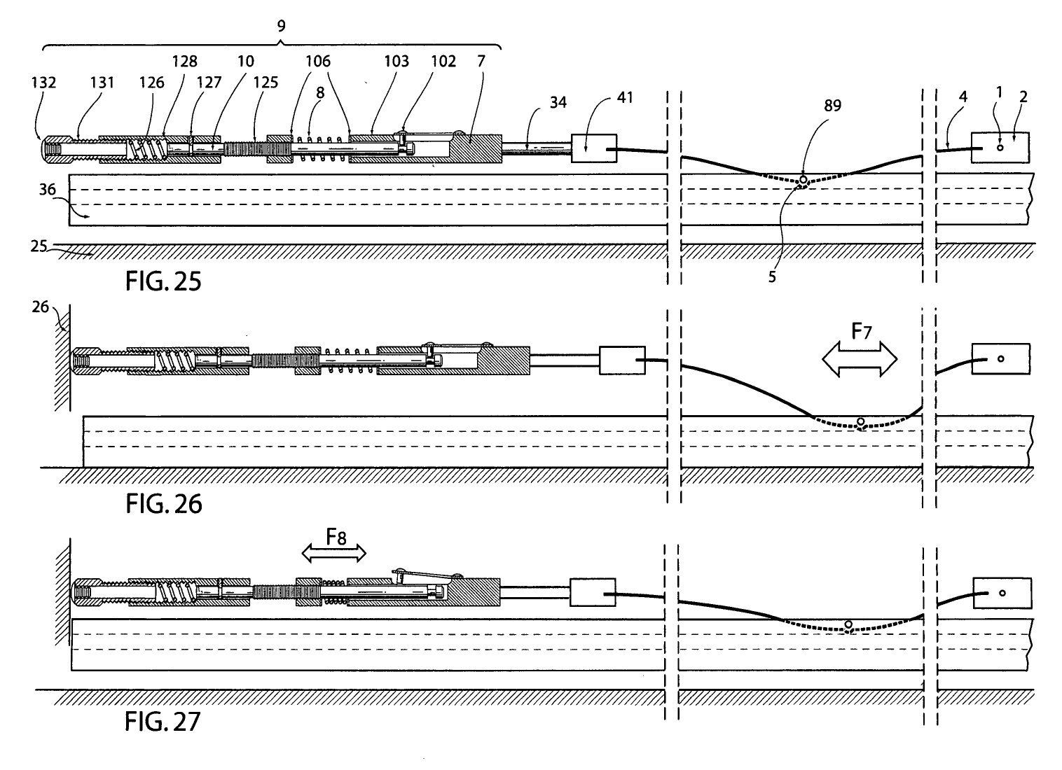

The end block 2 is fixed to channel 15 by similar means as shown in FIG. 6. Housing 7 is connected with shaft 34 to connecting block 41 which in turn connected to leaf spring 4. As shown in FIG. 25 a dimple 5 is coupled to sealing members 36 at in line holes at the rigid member 13 by means of pin 89. The coupling restricted any lengthwise movement of sealing element 36. Spring constant of leaf spring 4 is provided to be significantly larger that spring constant of helical helical spring 8.

FIGS. 25, 26, and 27 show respectively operating stages one, two, and three according to the third embodiment of the invention. Stage one represent a door in open position, stage two represent door in closed position. Stage four represent door in closed position with release mechanism activated.

During closing of the door 21, at one point, cushion 132 will engage with jamb 26 causing release mechanism to be driven into channel 15 along rails 18. The movement cause spring 4 to flex, forcing sealing members 36 partially out of the lower section of the channel 15 until it contact with door sill 15. It is arranged that portion of sealing members 36 from coupling point 93 toward hinged side of the door is relatively longer than portion of toward unhinged side. This to assure portion of sealing element 14 near hinged side will contact sill first, to minimize drag of sealing element 14 to sill 25 during closing of door 21. FIG. 26 show the second operating stage. Spring 4 will retain force F7. An activation of release mechanism by means of actuation as described in FIG. 5, 15, or 18 will cause shaft 10 to unlatch to housing 7, and spring 8 to be depressed and eventually retain force F8. Where F8 is significantly smaller than F7. FIG. 27 show the third operating stage of the Door Bottom according to the third embodiment of the invention where door 21 is closed and sealing members 36 is retracted into channel 15. When the door 21 is opened, cushion 132 disengage from jamb 26, and relieving pressure to shaft. Retained force F8 would cause spring to sprang and to pull shaft 10 out of housing 7 until its annular grove is latch again by latch pin 102. The release mechanism 9 is reset.

All publications, patents, and patent documents are incorporated by reference herein, as though individually incorporated by reference. Although the invention has been described with reference to a specific and preferred embodiment and technique, it should be appreciated by one of skill in the art that many variations and modifications may be made within the scope of this invention.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claimed:

1. An automatic door bottom for a hinged door with an independent release mechanism which is pivotable to be positioned over a sill when closed, the door having a hinge side and a width, said door bottom comprising:
a sealing member having a length corresponding to the width of the door bottom;
an displacement mechanism responsive to closing of the door for moving said sealing member vertically downward into a sealing position relative to the sill when the door is closed beginning with the hinge side of the door;
said displacement mechanism comprising at least one of elongated resilient members spaced along the width of said door bottom which may be configured as a first plurality of elements in sliding abutment against said sealing member and a second plurality of elements in sliding abutment toward said door;
a release mechanism responsive for moving said sealing member vertically upward into an open position relative to the sill even when the door is in the closed position; and
said release mechanism comprising a plurality of members attached to the displacement mechanism including a latching mechanism wherein a latching piece is returned to first latched position through the force exerted by a tension loaded mechanism when there is no external force acting thereon; a second opened position whereas the latching piece is released and the sealing member returns to a vertically upward position into a unsealing position relative to the sill even when door is in the closed position.

2. An apparatus as in claim 1 whereas said release mechanism is a plurality of members including a rigid member within said displacement mechanism with at least one cavity to receive a stopping mechanism through said cavity to ensure a fixed length rigid member couple with a longitudinal tensional member having the least resistance to deformation than said resilient members exerting a lateral force through the displacement mechanism; a housing with a chamber to receive the rigid member with an orifice to allow the stopping mechanism through said cavity of the rigid member; said stopping mechanism is attached to a lateral resilient member mounted onto said housing exerting a downward force on the stopping mechanism; and a switching mechanism adjustably mounted onto said resilient member to remove the stopping mechanism from said cavity of the rigid member to allow the elongation of said resilient members in the bent position even when the door is closed.

3. An apparatus as in claim 1 whereas, said longitudinal tensional member is at least one spring exert lateral forces.

4. An apparatus as in claim 1 whereas, said longitudinal tensional member is adjustable by increasing the tension of the tensional member.

5. An apparatus as in claim 1 whereas, said release mechanism is located to the opposed end to the door hinge attached to the resilient member.

6. An apparatus as in claim 1 whereas, said switching mechanism is fixably attached to the rotational movement of a door lock moving the stopping mechanism from the blocking first position to the open second position.

7. An apparatus as in claim 1 whereas, said switching mechanism is fixably attached to the rotational movement of a door handle moving the stopping mechanism from the blocking first position to the open second position.

8. An apparatus as in claim 1 whereas, said switching mechanism is a solenoid electronically operated remotely to remove the stopping mechanism from the blocking first position to the open second position.

9. An apparatus as in claim 1 whereas, said switching mechanism in which the stopping mechanism is a vertical member is located on and through the top surface of the apparatus with a tension mechanism forcing said stopping mechanism in the blocked first position.

10. An apparatus as in claim 1 whereas, said switching mechanism is a lever attached to a fulcrum whereas the rotational movement moves said stopping mechanism from the blocking first position to the open second position with a tensional force exerted rotational to return the stopping mechanism to the first position.

11. An apparatus as in claim 1 whereas, said switching mechanism may be operated on either side or both sides of the door.

12. An apparatus as in claim 1 whereas, said switching mechanism may be operated via a mechanism connected onto a door knob mechanism, door lever mechanism or a door lock mechanism.

13. An apparatus as in claim 1 whereas said release mechanism is a plurality of members including a rigid member within said displacement mechanism and a switching mechanism adjustably mounted onto said resilient member containing a stopping mechanism which may effect the tension exerted by the rigid member to allow the elongation of said resilient members in the bent position even when the door is closed.

14. An apparatus as in claim 1 whereas said a cavity may be formed in said displacement mechanism so that additional mechanisms may be inserted into said cavity.

15. An apparatus as in claim 1 whereas said one of said resilient members being closest to said hinge side of said door, each of said resilient members having a resistance to bending, and said one of said resilient members having a lower resistance to bending than each other one of said resilient members.

16. An apparatus as in claim 1 whereas said sliding abutment is on both hinge side of the door and unhinged side.

17. An automatic sweep for a sliding door movable between an open position and a closed position, the sweep comprising:
an elongate seal member adapted to be coupled to a bottom end of the door for movement between a raised position and a lowered position; and
means for moving the seal member between said raised position and said lowered position, comprising: an elongate operating element that extends generally parallel to and above the seal member and is longitudinally displaceable between first and second positions corresponding respectively to open and closed positions of the door;
means coupling said operating element with the seal member and adapted to translate said longitudinal displacement of the operating element into movement of the seal member between said raised and lowered positions, and displacement mechanism means that projects laterally of the sweep for co-operation with stationary abutment means adjacent an opening to be closed by the door in use, said displacement mechanism means and abutment means co-operating to cause movement of said operating element to its said second position as the door moves to its closed position, moving the seal member to its lowered position and to cause movement of said operating element from said second position to said first position as the door is moved away from its said closed position towards its open position, raising the seal member, a release mechanism comprising a plurality of members attached to said displacement mechanism including a latching mechanism wherein a latching piece is returned to first latched position through the force exerted by a tension loaded mechanism when there is no external force acting thereon; and
a second open position whereas the latching piece is released and the seal member returns to a vertically upward position into a unsealing position relative to the sill even when door is in the closed position; and
a release mechanism responsive for moving said sealing member vertically upward into an second open position relative to the sill even when the door is in the closed position; and
said release mechanism comprising a plurality of members attached to the displacement mechanism including a latching mechanism wherein a latching piece is returned to first latched position through the force exerted by a tension loaded mechanism when there is no external force acting thereon; a second opened position whereas the latching piece is released and the sealing member returns to a vertically upward position into a unsealing position relative to the sill even when door is in the closed position.

18. An automatic door bottom for a hinged door with an independent release mechanism which is pivotable to be positioned over a sill when closed, the door having a hinge side and a width, said door bottom comprising:
a sealing member having a length corresponding to the width of the door bottom;
an displacement mechanism responsive to closing of the door for moving said sealing member vertically downward into a sealing position relative to the sill when the door is closed beginning with the hinge side of the door;
said displacement mechanism comprising at least one of elongated resilient members spaced along the width of said door bottom which may be configured as a first plurality of elements in sliding abutment against said sealing member and a second plurality of elements in sliding abutment toward said door;
a release mechanism responsive for moving said sealing member vertically upward into an open position relative to the sill even when the door is in the closed position; and
said release mechanism comprising a plurality of members attached to the displacement mechanism including a latching mechanism wherein a latching piece is returned to first latched position through an external force acting thereon; a second opened position whereas the latching piece is released and the sealing member returns to a vertically upward position into a unsealing position relative to the sill even when door is in the closed position.

19. An automatic door bottom for a hinged door with an independent release mechanism which is pivotable to be positioned over a sill when closed, the door having a hinge side and a width, said door bottom comprising:
a sealing member having a length corresponding to the width of the door bottom;
an displacement mechanism responsive to closing of the door for moving said sealing member vertically downward into a sealing position relative to the sill when the door is closed beginning with the hinge side of the door;
a release mechanism responsive for moving said sealing member vertically upward into an open position relative to the sill even when the door is in the closed position; and
said release mechanism comprising a plurality of members attached to the displacement mechanism including a latching mechanism wherein a latching piece is returned to first latched position through the force exerted by a tension loaded mechanism when there is no external force acting thereon; a second opened position whereas the latching piece is released and the sealing member returns to a vertically upward position into a unsealing position relative to the sill even when door is in the closed position.
